(19) United States
(12) Patent Application Publication
(10) Pub. No.: US 2010/0270019 A1
(43) Pub. Date: Oct. 28, 2010

(54) METHOD OF OBTAINING A TREATMENT COMPOSITION FOR IMPROVING THE PRODUCTIVITY OF HYDROCARBON PRODUCING WELLS

(75) Inventors: Gary A. Pope, Austin, TX (US); Jimmie R. Baran, JR., Prescott, WI (US)

Correspondence Address: CHALKER FLORES, LLP, 2711 LBJ FRWY, Suite 1036, DALLAS, TX, 75234, US

(73) Assignees: BOARD OF REGENTS, THE UNIVERSITY OF TEXAS SYSTEM, Austin, TX (US); 3M INNOVATIVE PROPERTIES COMPANY, St. Paul, MN (US)

(21) Appl. No.: 12/302,017

(22) PCT Filed: Aug. 22, 2007
(86) PCT No.: PCT/US07/76562

§ 371 Date: Jul. 7, 2010

(30) Foreign Application Priority Data
Aug. 23, 2006 (US) 11508690

(51) Int. Cl. E21B 43/16; G06G 7/48

(52) U.S. Cl. 166/305.1; 703/6

(57) ABSTRACT

A method of obtaining a treatment composition for treating a hydrocarbon-bearing clastic formation having brine therein to enhance recovery of hydrocarbon from the formation. The method comprises: obtaining a formation information set comprising a temperature value, brine content value, and brine composition data obtained from a geological zone of the hydrocarbon-bearing clastic formation; comparing the formation information set to a compatibility information set to generate a comparison information set, the compatibility information set comprising compatibility information for at least at least one model brine and at least one model composition at least one model temperature; selecting a treatment composition based, at least in part, on the at least one comparison information set, wherein the treatment composition comprises a second surfactant dissolved in a second solvent; and obtaining the treatment composition for treating the hydrocarbon-bearing clastic formation to enhance recovery of hydrocarbon from the formation.

### CROSS-REFERENCE TO RELATED APPLICATIONS

This application claims priority to U.S. Provisional application Ser. No. 11/508,690, filed Aug. 23, 2006, and claims priority to and is a 35 U.S.C. §371, National Phase filing of PCT Application Serial No., PCT/US2007/076,562, filed Aug. 22, 2007, the entire contents of both are incorporated herein by reference.

### BACKGROUND

It is known in the subterranean well drilling art that in some wells (e.g., some oil and/or gas wells) brine is present in hydrocarbon-bearing geological formations in the vicinity of the wellbore (also known in the art as the “near wellbore region”). The brine may be naturally occurring (e.g., connate water) and/or may be a result of operations conducted on the well.

In the case of some wells (e.g., some gas wells), liquid hydrocarbons (also known in the art as “condensate”) can form and accumulate in the near wellbore region. The presence of condensate can cause a large decrease in both the gas and condensate relative permeabilities, and thus the productivity of the well decreases.

The presence of brine and/or gas condensate in a near wellbore region of a hydrocarbon-bearing geological formation can inhibit or stop production of hydrocarbons from the well, and hence is typically undesirable.

Various approaches have been tried for increasing the hydrocarbon production of such wells. One approach, for example, involves a fracturing and propping operation (e.g., prior to, or simultaneously with, a gravel packing operation) to increase the permeability of the hydrocarbon-bearing geological formation adjacent to the wellbore. Chemical treatments (e.g., injection of methanol) have also been used to improve productivity of such oil and/or gas wells. The latter treatments are typically injected into the near wellbore region of a hydrocarbon-bearing geological formation where they interact with the brine and/or condensate to displace and/or dissolve it, thereby facilitating increased hydrocarbon production from the well.

Conventional treatments for increasing the hydrocarbon production from wells having brine and/or condensate in the near wellbore region of a hydrocarbon-bearing geological formation, however, are often relatively short-lived, and require expensive and time-consuming retreatment.

Identifying useful chemical treatments that will be effective for increasing hydrocarbon productivity and be persistent remains a problem, especially since well conditions such as temperature, brine content and brine composition may vary between wells and/or may even vary over time within a given well.

### SUMMARY

In one aspect, the present invention provides a method of obtaining a treatment composition for treating a hydrocarbon-bearing clastic formation having brine therein to enhance recovery of hydrocarbon from the formation, the method comprising; obtaining a formation information set comprising a temperature value, brine content value, and brine composition data obtained from a geological zone of the hydrocarbon-bearing clastic formation; comparing the formation information set to a compatibility information set to generate a comparison information set, the compatibility information set comprising compatibility information for at least at least one model brine and at least one model composition at least one model temperature, wherein each at least one model composition independently comprises at least one first surfactant dissolved in at least one first solvent; selecting a treatment composition based, at least in part, on the at least one comparison information set, wherein the treatment composition comprises a second surfactant dissolved in a second solvent; and obtaining the treatment composition for treating the hydrocarbon-bearing clastic formation to enhance recovery of hydrocarbon from the formation.

In some embodiments, selecting the treatment composition comprises interpolating (e.g., between compatibility information set data points). In some embodiments, obtaining the treatment composition comprises preparing the treatment composition.

In some embodiments, the formation information set further comprises condensate content and condensate composition obtained from the geological zone of the hydrocarbon-bearing clastic formation. In some embodiments, at least a portion of the at least one information set is generated by computer simulation. In some embodiments, the at least one first surfactant comprises the second surfactant. In some embodiments, the at least one first solvent comprises the second solvent. In some embodiments, the formation information set further comprises condensate content obtained from the geological zone of the hydrocarbon-bearing clastic formation. In some embodiments, the second solvent comprises water. In some embodiments, the second solvent comprises at least one water-miscible organic solvent. In some embodiments, the second solvent comprises at least two organic solvents. In some embodiments, the at least one compatibility information set comprises compatibility information regarding the at least one model brine and a plurality of model compositions at a plurality of model temperatures.

In some embodiments, the at least one compatibility information set comprises compatibility information regarding the at least one model brine and a plurality of model compositions. In some of these embodiments, the plurality of model compositions comprises a third surfactant different from the first surfactant.

In some embodiments, the plurality of model temperatures has a highest model temperature and a lowest model temperature, and the temperature obtained from the geological zone of the hydrocarbon-bearing clastic formation has a value of from at least the lowest model temperature up to and including the highest model temperature. In some of these embodiments, the at least one model temperature comprises a model temperature that has the same value as the temperature obtained from the geological zone of the hydrocarbon-bearing clastic formation.

In some embodiments, the compatibility information set comprises compatibility information regarding a plurality of model brines and a plurality of model compositions at a plurality of model temperatures. In some embodiments, the at least one model brine is selected based at least in part on the brine composition data obtained from the geological zone of the hydrocarbon-bearing clastic formation. In some embodiments, at least one model brine has the same composition as the brine composition data obtained from the geological zone of the hydrocarbon-bearing clastic formation. In some embodiments, the surfactant is fluorinated. In some embodiments, the surfactant is fluorinated and nonionic.

In some embodiments, the method further comprises injecting the treatment composition into a specimen of the geological zone of the hydrocarbon-bearing clastic formation.

In another aspect, the present inventions provides a method of treating a geological zone of a hydrocarbon-bearing clastic formation having brine therein, the method comprising injecting the treatment composition obtained according to the method of the present invention into the geological zone of the hydrocarbon-bearing clastic formation.

The following definitions of terms apply throughout the specification and claims.

The term “brine” refers to water having at least one dissolved electrolyte salt therein (e.g., having any nonzero concentration, and which may be less than 1000 parts per million by weight (ppm), or greater than 1000 ppm, greater than 10,000 ppm, greater than 20,000 ppm, 30,000 ppm, 40,000 ppm, 50,000 ppm, 100,000 ppm, 150,000 ppm, or even greater than 200,000 ppm).

The term “brine composition data” refers to data identifying the amounts and identities of chemical constituents in the brine referred to.

The term “compatibility information” refers to information concerning the phase stability of a solution or dispersion.

### BRIEF DESCRIPTION OF THE DRAWING

For a more complete understanding of the features and advantages of the present invention, reference is now made to the detailed description along with the accompanying figures and in which:

FIG. 1 is a schematic illustration of an exemplary embodiment of an offshore oil and gas platform operating an apparatus for progressively treating a near wellbore region according to the present invention; and

FIG. 2 is a schematic illustration of the core flood set-up used for the Examples.

### DETAILED DESCRIPTION

Any surfactant or combination of surfactants may be useful in methods according to the present invention, including, for example, anionic surfactants, cationic surfactants, nonionic surfactants, amphoteric surfactants (e.g., zwitterionic surfactants), and combinations thereof.

Many of each type of surfactant are widely available to one skilled in the art. These include, for example, fluorochemical, silicone and hydrocarbon-based surfactants.

Examples of useful anionic surfactants include alkali metal and (alkyl)ammonium salts of: alkyl sulfates and sulfonates such as sodium dodecyl sulfate and potassium dodecanesulfonate; sulfates of polyethoxylated derivatives of straight or branched chain aliphatic alcohols and carboxylic acids; alkylbenzenesulfonates, alkylnaphthalenesulfonates and sulfates (e.g., sodium laurylbenzenesulfonate); ethoxylated and polyethoxylated alkyl and aralkyl alcohol carboxylates; glycinates such as alkyl sarcosinates and alkyl glycinates; sulfosuccinates including dialkyl sulfosuccinates; isethionate derivatives; N-acyltaurine derivatives such as sodium N-methyl-N-oleyl taurate); and alkyl phosphate mono- or di-esters such as ethoxylated dodecyl alcohol phosphate ester, sodium salt.

Examples of useful cationic surfactants include: alkylammonium salts having the formula CᵣH₂ᵣ₊₁N(CH₃)₃X, where X is OH, Cl, Br, HSO₄ or a combination of OH and Cl, and where r is an integer from 8 to 22, and the formula CₛHₛ₊₁N(C₂H₅)₃X, where s is an integer from 12 to 18 and X is as defined above; gemini surfactants, for example, those having the formula: [C₁₆H₃₃N(CH₃)₂CₜH₂ₜ₊₁]X, wherein t is an integer from 2 to 12 and X is as defined above; aralkylammonium salts (e.g., benzalkonium salts); and cetylethylpiperidinium salts, for example, C₁₆H₃₃N(C₂H₅)(C₅H₁₀)X, wherein X is as defined above.

Examples of useful amphoteric surfactants include alkyldimethyl amine oxides, alkylcarboxamidoalkylenedimethyl amine oxides, aminopropionates, sulfobetaines, alkyl betaines, alkylamidobetaines, dihydroxyethyl glycinates, imidazoline acetates, imidazoline propionates, ammonium carboxylate and ammonium sulfonate amphoterics and imidazoline sulfonates.

Examples of useful hydrocarbon nonionic surfactants include polyoxyethylene alkyl ethers, polyoxyethylene alkyl-phenyl ethers, polyoxyethylene acyl esters, sorbitan fatty acid esters, polyoxyethylene alkylamines, polyoxyethylene alkylamides, polyoxyethylene lauryl ethers, polyoxyethylene cetyl ethers, polyoxyethylene stearyl ethers, polyoxyethylene oleyl ether, polyoxyethylene octylphenyl ethers, polyoxyethylene nonylphenyl ethers, polyethylene glycol laurates, polyethylene glycol stearates, polyethylene glycol distearates, polyethylene glycol oleates, oxyethylene-oxypropylene block copolymer, sorbitan laurate, sorbitan stearate, sorbitan distearate, sorbitan oleate, sorbitan sesquioleate, sorbitan trioleate, polyoxyethylene sorbitan laurates, polyoxyethylene sorbitan stearates, polyoxyethylene sorbitan oleates, polyoxyethylene laurylamines, polyoxyethylene laurylamides, laurylamine acetate, ethoxylated tetramethyldecynediol, fluoroaliphatic polymeric ester, and polyether-polysiloxane copolymers.

Useful nonionic surfactants also include nonionic fluorinated surfactants. Examples include nonionic fluorinated surfactants marketed under the trade designation “ZONYL” (e.g., ZONYL FSO) by E. I. du Pont de Nemours and Co., Wilmington, Del.

Nonionic fluorinated polymeric surfactants such as, for example, Fluorosurfactant A and Fluorosurfactant B (both described in the Examples hereinbelow) may also be used.

In some embodiments, the nonionic fluorinated polymeric surfactant comprises:
(a) at least one divalent unit represented by the formula:

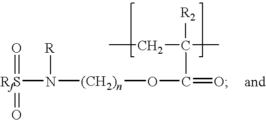

(b) at least one divalent unit represented by a formula:

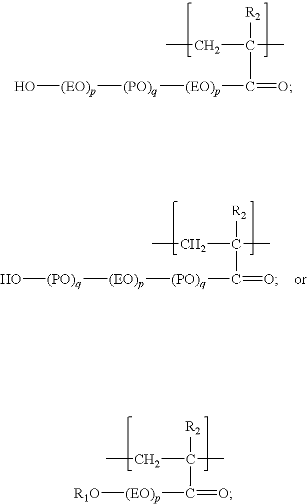

wherein:
R_{f} represents a perfluoroalkyl group having from 1 to 8 carbon atoms. Exemplary groups R_{f} include perfluoromethyl, perfluoroethyl, perfluoropropyl, perfluorobutyl (e.g., perfluoro-n-butyl or perfluoro-sec-butyl), perfluoropentyl, perfluorohexyl, perfluoroheptyl, and perfluorooctyl.
R, R₁, and R₂ are each independently hydrogen or alkyl of 1 to 4 carbon atoms (e.g., methyl, ethyl, n-propyl, isopropyl, butyl, isobutyl, or t-butyl).
n is an integer from 2 to 10.
EO represents —CH₂CH₂O—.
Each PO independently represents —CH(CH₃)CH₂O— or —CH₂CH(CH₃)O—.
Each p is independently an integer of from 1 to about 128.
Each q is independently an integer of from 0 to about 55. Useful nonionic fluorinated polymeric surfactants typically have a number average molecular weight in the range of from 1,000 to 10,000 grams/mole, 20,000 grams/mole, or even 30,000 grams/mole, although higher and lower molecular weights may also be used.

Such nonionic fluorinated polymeric surfactants may be prepared by techniques known in the art, including, for example, by free radical initiated copolymerization of a nonafluorobutanesulfonamido group-containing acrylate with a poly(alkyleneoxy) acrylate (e.g., monoacrylate or diacrylate) or mixtures thereof. Adjusting the concentration and activity of the initiator, the concentration of monomers, the temperature, and the chain-transfer agents can control the molecular weight of the polyacrylate copolymer. The description of the preparation of such polyacrylates is described, for example, in U.S. Pat. No. 3,787,351 (Olson). Preparation of nonafluorobutanesulfonamido acrylate monomers are described, for example, in U.S. Pat. No. 2,803,615 (Ahlbrecht et al.), the disclosure of which is incorporated herein by reference. Examples of fluoroaliphatic polymeric esters and their preparation are described, for example, in U.S. Pat. No. 6,664,354 (Savu et al.).

Methods described above for making nonafluorobutylsulfonamido group-containing structures can be used to make heptafluoropropylsulfonamido groups by starting with heptafluoropropylsulfonyl fluoride, which can be made, for example, by the methods described in Examples 2 and 3 of U.S. Pat. No. 2,732,398 (Brice et al.), the disclosure of which is incorporated herein by reference.

Any solvent or combination of solvents may be used in model brines, model compositions, model condensates, and treatment compositions. Examples of useful solvents include organic solvents, water, and combinations thereof. Examples of organic solvents include polar and/or water-miscible solvents such as, for example: monohydroxy alcohols having from 1 to 4 or more carbon atoms such as, for example, methanol, ethanol, isopropanol, propanol, or butanol; polyols such as, for example, glycols (e.g., ethylene glycol or propylene glycol), terminal alkanediols (e.g., 1,3-propanediol, 1,4-butanediol, 1,6-hexanediol, or 1,8-octanediol), polyglycols (e.g., diethylene glycol, triethylene glycol, or dipropylene glycol) or triols (e.g., glycerol, trimethylolpropane); ethers such as, for example, diethyl ether, methyl t-butyl ether, tetrahydrofuran, p-dioxane, or polyol ethers (e.g., glycol ethers (e.g., ethylene glycol monobutyl ether, diethylene glycol monomethyl ether, dipropylene glycol monomethyl ether, propylene glycol monomethyl ether, or those glycol ethers available under the trade designation “DOWANOL” from Dow Chemical Co., Midland, Mich.)); ketones (e.g., acetone or 2-butanone); and combinations thereof.

In some embodiments, component(s) of the solvent may have a normal boiling point of less than 650° F. (343° C.); for example, to facilitate removal of the solvent from a well after treatment.

The various model brines, model compositions, model condensates, and treatment compositions used herein may be prepared by any suitable method including, for example, manually or mechanically shaking and/or stirring the various components thereof. The first data set is typically obtained by measurement of the pertinent condition(s) in or near a wellbore located at a particular geological zone of interest in a hydrocarbon-bearing clastic formation. Suitable measurement methods are known to the skilled artisan. In some instances further manipulation of data (e.g., computer calculations) obtained from hydrocarbon-bearing clastic formation may be useful, and such manipulation is within the scope of the present invention.

The second data set may be generated by various methods including, computer simulation, physical measurements or a combination thereof. The second data set may be as small as a single set element (e.g., a measurement of compatibility between the surfactant-solvent formulation and the brine and/or condensate at a given temperature), or it may contain any higher number of set elements. Typically, the choice of surfactant-solvent formulations and temperatures to be studied and the results included within the second set will be directed by intuition and experience on the part of the skilled artisan performing the method, but this is not a requirement.

One convenient method of evaluating compatibility involves combining in (e.g., a container) a model brine and/or model condensate with a surfactant-solvent formulation at a given temperature, and then mixing the model brine and/or model condensate with the surfactant-solvent formulation. The mixture is evaluated over time (e.g., 5 minutes, 1 hour, 12 hours, 24 hours or longer) to see if it phase separates or becomes cloudy. By adjusting the relative amounts of model brine and/or model condensate and the surfactant-solvent formulation, it is possible to determine the maximum brine and/or condensate uptake capacity (above which phase separation occurs) of the surfactant-solvent formulation at a given temperature. Varying the temperature at which the above procedure is carried out typically results in a more complete understanding of the suitability of surfactant solvent formulations as treatment compositions for a given well. In addition, in calculating and/or measuring interactions of the model brine and/or model condensate with a surfactant-solvent formulation, it is also contemplated that one may be able obtain the second data set, in whole or in part, by simply referring to previously determined, collected, and/or tabulated information (e.g., in a handbook or a computer database).

Without wishing to be bound by theory, it is believed that more desirable well treatment results are obtained when the treatment composition used in a particular near wellbore region of a well is homogenous at the temperature(s) encountered in the near wellbore region. Accordingly, the treatment composition is typically selected to be homogenous at temperature(s) found in the portion of hydrocarbon-bearing clastic formation (e.g., a near well bore region) to be treated.

The formation and compatibility information sets thus created are compared and a treatment composition is chosen based at least in part on the comparison. In general, a treatment composition is chosen that closely resembles, or is identical to, a surfactant-solvent formulation from the compatibility information set, but this is not a requirement. For example, cost, availability, regulations, flammability, and environmental concerns may influence the specific choice of treatment composition for use in testing and/or commercial production.

Once selected, the treatment compositions may be further evaluated; for example, by injection into a specimen (e.g., a core sample) taken from a particular geological zone to be treated, or a closely similar specimen. This may be performed in a laboratory environment using conventional techniques such as, for example, those described by Kumar et al. in “Improving the Gas and Condensate Relative Permeability Using Chemical Treatments”, paper SPE 100529, presented at the 2006 SPE Gas Technology Symposium held in Calgary, Alberta, Canada, 15-17 May 2006.

Embodiments of treatment compositions according to the present invention may be useful, for example, for recovering hydrocarbons (e.g., at least one of methane, ethane, propane, butane, hexane, heptane, or octane) from hydrocarbon-bearing subterranean clastic formations (in some embodiments, predominantly sandstone).

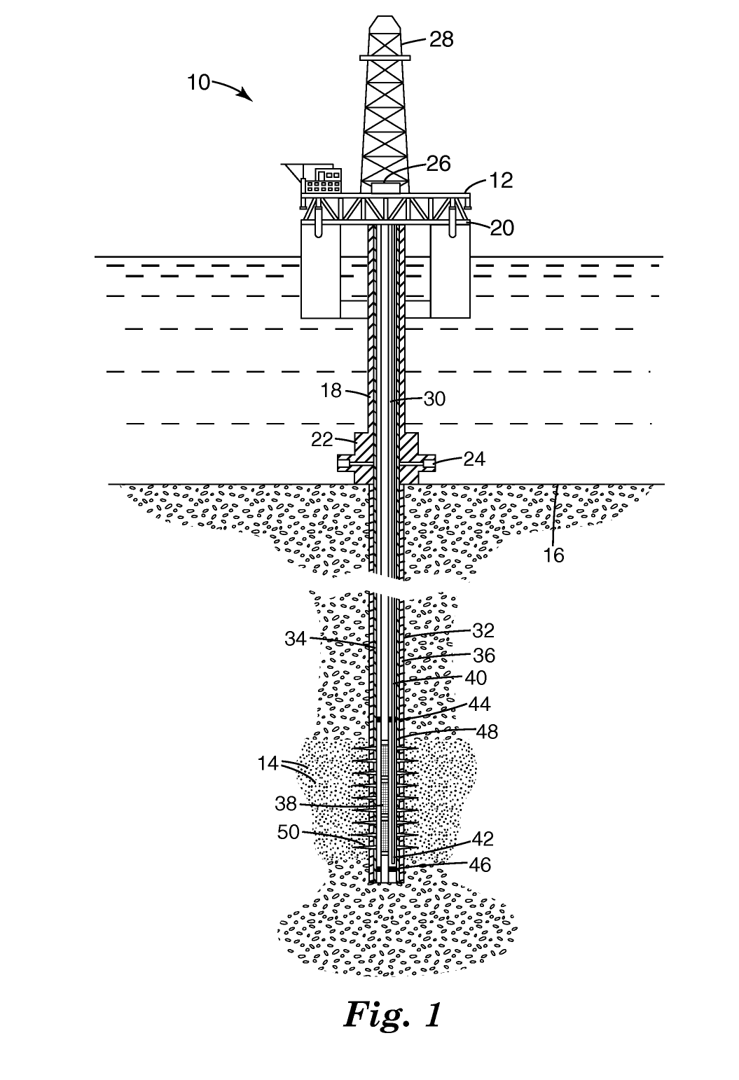

Referring now to FIG. 1, an exemplary offshore oil and gas platform is schematically illustrated and generally designated 10. Semi-submersible platform 12 is centered over submerged hydrocarbon-bearing clastic formation 14 located below sea floor 16. Subsea conduit 18 extends from deck 20 of platform 12 to wellhead installation 22 including, for example, blowout preventers 24. Platform 12 is shown with hoisting apparatus 26 and derrick 28 for raising and lowering pipe strings such as work string 30.

Wellbore 32 extends through the various earth strata including hydrocarbon-bearing clastic formation 14. Casing 34 is cemented within wellbore 32 by cement 36. Work string 30 may include various tools including, for example, sand control screen assembly 38 which is positioned within wellbore 32 adjacent to hydrocarbon-bearing clastic formation 14. Also extending from platform 12 through wellbore 32 is fluid delivery tube 40 having fluid or gas discharge section 42 positioned adjacent to hydrocarbon-bearing clastic formation 14, shown with production zone 48 between packers 44, 46. When it is desired to treat the near-wellbore region of hydrocarbon-bearing clastic formation 14 adjacent to production zone 48, work string 30 and fluid delivery tube 40 are lowered through casing 34 until sand control screen assembly 38 and fluid discharge section 42 are positioned adjacent to the near-wellbore region of hydrocarbon-bearing clastic formation 14 including perforations 50. Thereafter, a treatment composition described herein is pumped down delivery tube 40 to progressively treat near-wellbore region 55 of hydrocarbon-bearing clastic formation 14.

While the drawing depicts an offshore operation, the skilled artisan will recognize that the treatment compositions and methods for treating a production zone of a wellbore are equally well-suited for use in onshore operations. Also, while the drawing depicts a vertical well, the skilled artisan will also recognize that treatment compositions and methods for wellbore treatment of the present invention are equally well-suited for use in deviated wells, inclined wells or horizontal wells.

Methods of using treatment compositions obtained herein are useful, for example on both existing and new wells. Typically, it is believed to be desirable to allow for a shut-in time after treatment compositions described herein are contacted with the hydrocarbon-bearing clastic formations. Exemplary set in times include a few hours (e.g., 1 to 12 hours), about 24 hours, or even a few (e.g., 2 to 10) days.

The skilled artisan, after reviewing the instant disclosure, will recognize that various factors may be taken into account in practice of the present invention including, for example, the ionic strength of the treatment composition, pH (e.g., a range from a pH of about 4 to about 10), and the radial stress at the wellbore (e.g., about 1 bar (100 kPa) to about 1000 bars (100 MPa)).

Treatment compositions prepared according to the present invention are typically useful for treating hydrocarbon-bearing clastic formations (e.g., hydrocarbon-bearing clastic formation that are predominantly sandstone), especially those containing brine. Typically, after treatment according to the present invention hydrocarbons are then obtained from the wellbore at an increased rate, as compared the rate prior to treatment.

In addition to brine and/or condensate, other materials such as e.g., asphaltene may be present in the hydrocarbon-bearing clastic formation. Treatment compositions prepared according to methods of the present invention may also be used in those cases.

Treatment compositions prepared according to methods of the present invention may be injected into hydrocarbon-bearing clastic formations in wells using methods (e.g., by pumping under pressure) well known to those skilled in the oil and gas art.

Hydraulic fracturing is commonly used to increase the productivity of brine blocked wells, that is, wells that have brine in the near wellbore region of a hydrocarbon-bearing geological formation. The hydraulic fracturing method is relatively expensive, and may not be applicable in some cases where brine is present, for example, as fracturing into additional brine bearing geological regions may occur. However, in some instances it may be desirable to utilize fracturing techniques and/or proppants as known in the art in conjunction with the instant invention to increase the production of hydrocarbon extraction from subterranean clastic formations. It may also be desirable to treat proppant with a treatment composition described herein prior to injecting the well. Sand proppants are available, for example, from Badger Mining Corp., Berlin, Wis.; Borden Chemical, Columbus, Ohio; Fairmont Minerals, Chardon, Ohio. Thermoplastics proppants are available, for example, from the Dow Chemical Company, Midland, Mich.; and BJ Services, Houston, Tex. Clay-based proppants are available, for example, from CarboCeramics, Irving, Tex.; and Saint-Gobain, Courbevoie, France. Sintered bauxite ceramic proppants are available, for example, from Borovichi Refractories, Borovichi, Russia; 3M Company, St. Paul, Minn.; CarboCeramics; and Saint Gobain. Glass bubble and bead proppants are available, for example, from Diversified Industries, Sidney, British Columbia, Canada; and 3M Company.

In some embodiments, treatment compositions prepared according to the present invention are injected into the hydrocarbon-bearing clastic formation during fracturing, after fracturing, or during and after fracturing the hydrocarbon-bearing clastic formation.

Advantages and embodiments of this invention are further illustrated by the following examples, but the particular materials and amounts thereof recited in these examples, as well as other conditions and details, should not be construed to unduly limit this invention. Unless otherwise noted, all parts, percentages, ratios, etc. in the examples and the rest of the specification are by weight. In the Tables, “nd” means not determined.

### EXAMPLES

### Preparation of Fluorosurfactant A

Fluorosurfactant A was prepared essentially as in Example 4 of U.S. Pat. No. 6,664,354

(Savu), except using 15.6 grams (g) of 50/50 mineral spirits/TRIGONOX-21-050 organic peroxide initiator (tert-butyl peroxy-2-ethylhexanoate available from Akzo Nobel, Arnhem, the Netherlands) in place of 2,2′-azobisisobutyronitrile, and with 9.9 g of 1-methyl-2-pyrrolidinone added to the charges.

### Preparation of Fluorosurfactant B

Fluorosurfactant B was prepared essentially as in Example 4 of U.S. Pat. No. 6,664,354 (Savu), except using N-methylperfluorobutanesulfonamidoethyl acrylate (MeFBSEA) and PLURONIC acrylate in a weight ratio of 38:62 and 15.6 g of 50/50 mineral spirits/TRIGONOX-21-050 organic peroxide initiator in place of 2,2′-azobisisobutyronitrile, and with 9.9 g of 1-methyl-2-pyrrolidinone added to the charges.

### Formation Information Set

The following information was obtained from a gas well:
temperature=275° F. (135° C.);
brine content=26 percent;
composition: Ca=2096 ppm, Sr=444 ppm, Ba=212 ppm, Mg=396 ppm, K=277 ppm, Na=21015 ppm, Fe (dissolved)=9 ppm, Fe (Total)=10 ppm, counterion was chloride.

### Compatibility Information Set

### Compatibility Tests 1-23

### General Procedure

Fluorosurfactant A (0.06 gram (g)) and two solvents (Solvent 1 and Solvent 2, 3 g total amount) were added to a vial to prepare a sample. A sample of model brine prepared from the corresponding metal chloride salts in the amounts indicated from the gas well mentioned hereinabove (0.25 g) was added to the vial, the vial was shaken by hand and the vial was placed in a heated bath at 90° C. for 1 hour. The vial was removed from the bath, and then visually inspected to determine whether the sample was one phase. If the sample was one-phase, the brine addition, shaking and heating steps were repeated until the sample was no longer one-phase.

The solvents used for each Compatibility Test and the initial amounts of the solvents are shown in Table 1 (below), wherein indicated weight percents of model brine are based on the combined total weight of the solvents, model brine, and surfactant.

TABLE 1

| | | | MODEL | MODEL |
|---|---|---|---|---|
| | | | BRINE | BRINE |
| | | | (wt. %) | (wt. %) |
| COMPATI- | SOLVENT 1 | SOLVENT 2 | NO PHASE | PHASE- |
| BILITY | (parts by | (parts by | SEPARA- | SEPA- |
| TEST | weight) | weight) | TION | RATED |
| 1 | 1,3-propanediol | isopropanol | 13.6 | 21.5 |
| | (80) | (IPA) (20) | | |
| 2 | propylene | IPA (30) | 21.5 | 36.4 |
| | glycol | | | |
| | (PG) (70) | | | |
| 3 | PG (90) | IPA (10) | 19.7 | 24.6 |
| 4 | PG (80) | IPA (20) | 29 | 32.9 |
| 5 | ethylene glycol | ethanol (50) | nd | 24.6 |
| | (EG) (50) | | | |
| 6 | EG (70) | ethanol (30) | nd | 24.6 |
| 7 | propylene | ethanol (50) | nd | 24.6 |
| | glycol | | | |
| | monobutyl | | | |
| | ether | | | |
| | (PGBE) (50) | | | |
| 8 | PGBE (70) | ethanol (30) | 14.0 | nd |
| 9 | dipropylene | ethanol (50) | 24.6 | nd |
| | glycol | | | |
| | monomethyl | | | |
| | ether | | | |
| | (DPGME) (50) | | | |
| 10 | DPGME (70) | ethanol (30) | 47.3 | 49.5 |
| 11 | diethylene | ethanol (30) | 24.6 | nd |
| | glycol | | | |
| | monomethyl | | | |
| | ether | | | |
| | (DEGME) (70) | | | |
| 12 | triethylene | ethanol (50) | nd | 24.6 |
| | glycol | | | |
| | monomethyl | | | |
| | ether | | | |
| | (TEGME) (50) | | | |
| 13 | TEGME (70) | ethanol (30) | nd | 24.6 |
| 14 | 1,8-octanediol | ethanol (50) | 32.9 | nd |
| | (50) | | | |
| 15 | PG (70) | tetrahydrofuran | 24.6 | nd |
| | | (THF) (30) | | |
| 16 | PG (70) | acetone (30) | nd | 32.9 |
| 17 | PG (70) | methanol (30) | nd | 24.6 |
| 18 | 2- | ethanol (20) | 42.4 | 45.0 |
| | butoxyethanol | | | |
| | (BE) (80) | | | |
| 19 | BE (70) | ethanol (30) | 45.0 | 49.5 |
| 20 | BE (60) | ethanol (40) | 45.0 | 49.5 |
| 21 | PG (70) | ethanol (30) | 24.6 | 29.0 |
| 22 | EG (70) | IPA (30) | 3.8 | 7.3 |
| 23 | glycerol (70) | IPA (30) | nd | 7.6 |

### Compatibility Tests 24-28

The General Procedure described in Compatibility Tests 1-23 was followed with the modification that Fluorosurfactant B was used in place of the Fluorosurfactant A. The solvents used for each Compatibility Test and the initial amounts of the solvents are shown in Table 2 (below), wherein indicated weight percents of model brine are based on the combined total weight of the solvents, model brine, and surfactant.

TABLE 2

| | | | MODEL | MODEL |
|---|---|---|---|---|
| | | | BRINE | BRINE |
| | | | (wt. %) | (wt. %) |
| COMPATI- | SOLVENT 1 | SOLVENT 2 | NO PHASE | PHASE- |
| BILITY | (parts by | (parts by | SEPARA- | SEPA- |
| TEST | weight) | weight) | TION | RATED |
| 24 | PG (80) | IPA (20) | nd | 24.6 |
| 25 | PG (70) | IPA (30) | 24.6 | 29 |
| 26 | PG (60) | IPA (40) | 29 | 32.9 |
| 27 | DEGME (70) | Ethanol (30) | 24.6 | nd |
| 28 | DPGME (70) | Ethanol (30) | 24.6 | nd |

### Compatibility Tests 29-30

The General Procedure described in Compatibility Tests 1-23 was followed with the following modifications. The amount of surfactant used was 0.12 g, and water was used instead of brine. The solvents used for each Compatibility Test and the initial amounts of the solvents are shown in Table 3 (below), wherein indicated weight percents of model brine (water) are based on the combined total weight of the solvents, water, and surfactant.

TABLE 3

| | | | WATER | WATER |
|---|---|---|---|---|
| | | | (wt. %) | (wt. %) |
| COMPATI- | SOLVENT 1 | SOLVENT 2 | NO PHASE | PHASE- |
| BILITY | (parts by | (parts by | SEPARA- | SEPA- |
| TEST | weight) | weight) | TION | RATED |
| 29 | EG (70) | IPA (30) | 7.1 | 10.3 |
| 30 | PG (70) | IPA (30) | 31.6 | 38.1 |

### Comparison

A comparison was made between a Compatibility Information set containing Compatibility Tests 1, 2 and 23 and the Formation Information Set and Treatment Composition 1 was selected and prepared.

A comparison was made between a Compatibility Information set containing Compatibility Tests 1-28 and the Formation Information Set and Treatment Composition 2 was selected and prepared.

A comparison was made between a Compatibility Information set containing Compatibility Tests 1-30 and the Formation Information Set and Treatment Composition 3 was selected and prepared.

### Treatment Compositions 1-3

### General Procedure

Fluorosurfactant A (2% by weight) and two solvents were combined. The components were mixed together using a magnetic stirrer and magnetic stir bar. The solvents and amounts (in wt. % based on the total weight of the composition) used for each treatment composition are reported in Table 4, below.

TABLE 4

| TREATMENT | SOLVENT 1 | SOLVENT 2 |
|---|---|---|
| COMPOSITION | (wt. %) | (wt. %) |
| 1 | PG (69) | IPA (29) |
| 2 | DPGME (69) | ethanol (29) |
| 3 | PG (69) | ethanol (29) |

### Core Flood Evaluation

### Core Flood Setup:

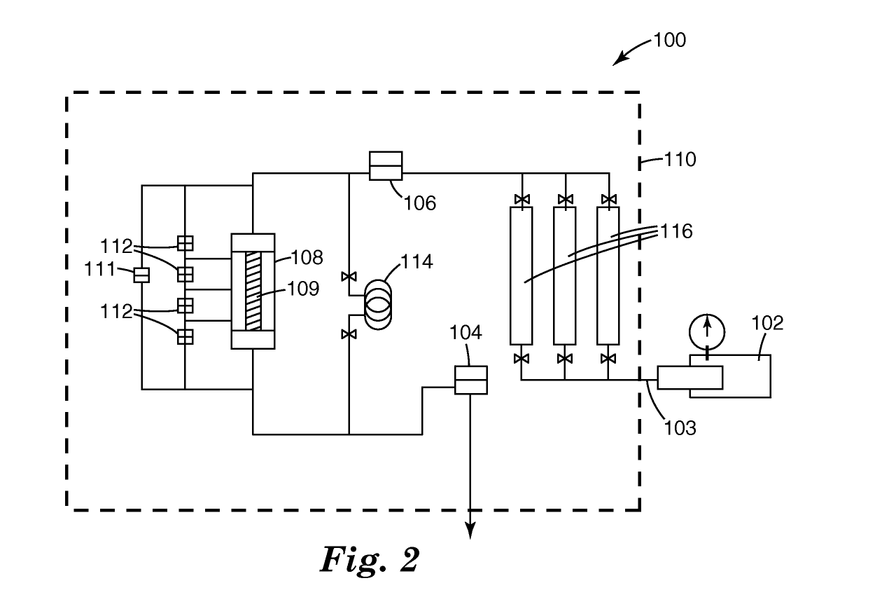

A schematic diagram of a core flood apparatus 100 used to determine relative permeability of a substrate sample (i.e., core) is shown in FIG. 2. Core flood apparatus 100 included positive displacement pumps (Model No. 1458; obtained from General Electric Sensing, Billerica, Mass.) 102 to inject fluid 103 at constant rate into fluid accumulators 116. Multiple pressure ports 112 on high-pressure core holder 108 (Hassler-type Model UTPT-1x8-3K-13 obtained from Phoenix, Houston Tex.) were used to measure pressure drop across four sections (2 inches in length each) of core 109. An additional pressure port 111 on core holder 108 was used to measure pressure drop across the entire length (8 inches) of core 109. In some experiments, pressure ports 112 were not used to make pressure measurements.

Two back-pressure regulators (Model No. BPR-50; obtained from Temco, Tulsa, Okla.) 104, 106 were used to control the flowing pressure upstream 106 and downstream 104 of core 109. A capillary viscometer 114 was placed in-line to evaluate fluid going through core 109. The capillary viscometer consisted of a stainless steel (SS-316) capillary tube with 1/16th inch (0.15875 centimeter (cm)) outer diameter purchased from Swagelok. The capillary viscometer was used to determine the viscosity of selected fluids and not for each core flood experiment.

The entire apparatus with the exception of the positive displacement pumps 102 was enclosed inside pressure- and temperature-controlled oven 110 (Model DC 1406F; maximum temperature rating of 650° F. (343° C.), obtained from SPX Corporation, Williamsport, Pa.) at 275° F. (135° C.). The maximum flow rate of fluid was 7,000 mL/hr. The flow of fluid was through a vertical core to avoid gravity segregation of the gas.

### Substrates:

The substrates for core flooding evaluation were Berea sandstone core plugs. Representative properties of these core plugs are reported in Table 5, below.

TABLE 5

| | Berea Sandstone |
|---|---|
| Diameter, inch (cm) | 1.0 (2.54) |
| Length, inch (cm) | 8.0 (20.32) |
| Pore volume, mL | 20.6 |
| Porosity, % | 20.0 |

The porosity was measured using either a gas expansion method or by the weight difference between a dry and a fully saturated core sample. The pore volume is the product of the bulk volume and the porosity.

### Synthetic Condensate Composition

A synthetic gas-condensate fluid containing 93% methane, 4% n-butane, 2% n-decane, and 1% n-pentadecane was used for the core flooding evaluation. Approximate values for properties of the fluid were measured and are reported Table 6, below.

TABLE 6

| | |
|---|---|
| Dewpoint, psig (Pa) | 4200 (2.9 × 10⁷) |
| Core pressure, psig (Pa) | 1500 (1.0 × 10⁷) |
| Liquid dropout, V/Vt % | 3.2 |
| Gas viscosity, cP | 0.017 |
| Oil viscosity, cP | 0.22 |
| Interfacial tension, | 5.0 |
| dynes/cm | |

### Core Preparation

The cores described in Table 5 were dried for 72 hours in a standard laboratory oven at 95° C., and then were wrapped in aluminum foil and heat shrink tubing (obtained under the trade designation “TEFLON HEAT SHRINK TUBING” from Zeus, Inc., Orangeburg, S.C.). Referring again to FIG. 2, the wrapped core 109 was placed in core holder 108 inside oven 110 at 75° F. (24° C.). An overburden pressure of 3400 psig (2.3×107 Pa) was applied. The initial single-phase gas permeability was measured using either nitrogen or methane at a flowing pressure of 1200 psig (8.3×106 Pa).

Brine, containing 92.25% water, 5.9% sodium chloride, 1.6% calcium chloride, 0.23% magnesium chloride hexahydrate, and 0.05% potassium chloride, was introduced into the core 109 by the following procedure. The outlet end of the core holder was connected to a vacuum pump and a full vacuum was applied for 30 minutes with the inlet closed. The inlet was connected to a burette with the brine in it. The outlet was closed and the inlet was opened to allow a known volume of brine to flow into the core. For example, a 26% connate water saturation (i.e., 26% of the pore volume of the core was saturated with water) was established by allowing 5.3 ml of brine to flow into the core before the inlet value was closed. The permeability was measured at connate water saturation by flowing nitrogen or methane gas at 1200 psig and 75° F. (24° C.).

### Core Flooding Procedure

Referring again to FIG. 2, the wrapped core 109 in the core holder 108 was placed inside oven 110 at 275° F. (135° C.) for several hours to allow it to reach reservoir temperature. The synthetic gas-condensate fluid described above was then introduced at a flow rate of about 690 mL/hr until steady state was established. Upstream back-pressure regulator 106 was set at about 4900 psig (3.38×107 Pa), above the dew point pressure of the fluid, and downstream back-pressure regulator 104 was set at about 1500 psig (3.38×107 Pa), corresponding to the bottom hole flowing well pressure. The gas relative permeability before treatment was then calculated from the steady state pressure drop. The surfactant composition was then injected into the core. After at least 20 pore volumes were injected, the surfactant composition was held in the core at 275° F. (135° C.) for about 15 hours. The synthetic gas condensate fluid described above was then introduced again at a flow rate of about 690 mL/hr using positive displacement pump 102 until a steady state was reached. The gas relative permeability after treatment was then calculated from the steady state pressure drop. Following the relative permeability measurements, methane gas was injected, using positive displacement pump 102, to displace the condensate and measure the final single-phase gas permeability to demonstrate that no damage had been done to the core.

For each Treatment Composition, the initial single-phase gas permeability, measured prior to brine saturation, the initial capillary number, the gas relative permeability before treatment with the surfactant composition, the gas relative permeability after treatment, and the ratio of the gas relative permeabilities after and before treatment (i.e., improvement factor) are reported in Table 7, below.

TABLE 7

TREATMENT COMPOSITION

| | 1 | 2 | 3 |
|---|---|---|---|
| Gas permeability, | 88.0 | 62 | 269 |
| millidarcy (md) | | | |
| Capillary number | 1.4 × 10⁻⁵ | 7.3 × 10⁻⁶ | 6.5 × 10⁻⁶ |
| Gas relative permeability | 0.074 | 0.24 | 0.12 |
| before treatment | | | |
| Gas relative permeability | 0.13 | 0.40 | 0.12 |
| after treatment | | | |
| Improvement factor | 1.7 | 1.7 | 1.0 |

The core flood evaluation procedure and conditions described for Treatment Composition 1 were followed, except the core flooding was conducted on a Reservoir Core A sandstone with the properties reported in Table 8, below.

TABLE 8

| | RESERVOIR |
|---|---|
| | CORE A |
| Diameter, inch (cm) | 1.0 (2.5) |
| Length, inch (cm) | 4.5 (11.4) |
| Pore volume (mL) | 6.2 |
| Porosity (%) | 10.8 |

The results from the core flooding experiment are reported in Table 9, below.

TABLE 9

| | Reservoir |
|---|---|
| | Core A |
| Gas permeability, md | 61 |
| Capillary number | 1.5 × 10⁻⁵ |
| Gas relative permeability before treatment | 0.074 |
| Gas relative permeability after treatment | 0.13 |
| Improvement factor | 1.7 |

Various modifications and alterations of this invention may be made by those skilled in the art without departing from the scope and spirit of this invention, and it should be understood that this invention is not to be unduly limited to the illustrative embodiments set forth herein.

What is claimed is:

1. A method of obtaining a treatment composition for treating a hydrocarbon-bearing clastic formation having brine therein to enhance recovery of hydrocarbon from the formation, the method comprising:
obtaining a formation information set comprising a temperature value, brine content value, and brine composition data obtained from a geological zone of the hydrocarbon-bearing clastic formation;
comparing the formation information set to a compatibility information set to generate a comparison information set, the compatibility information set comprising compatibility information for at least one model brine and at least one model composition at at least one model temperature, wherein each at least one model composition independently comprises at least one first surfactant dissolved in at least one first solvent;
selecting a treatment composition based, at least in part, on the comparison information set, wherein the treatment composition comprises a second surfactant dissolved in a second solvent; and
obtaining the treatment composition for treating the hydrocarbon-bearing clastic formation to enhance recovery of hydrocarbon from the formation.

2. The method of claim 1, wherein selecting the treatment composition comprises interpolating.

3. The method of claim 1, wherein obtaining the treatment composition comprises preparing the treatment composition.

4. A method of treating a geological zone of a hydrocarbon-bearing clastic formation having brine therein, the method comprising injecting the treatment composition obtained in claim 3 into the geological zone of the hydrocarbon-bearing clastic formation.

5. A method of treating a geological zone of a hydrocarbon-bearing clastic formation having brine therein, the method comprising injecting the treatment composition obtained in claim 1 into the geological zone of the hydrocarbon-bearing clastic formation.

6. The method of claim 1, wherein the formation information set further comprises condensate content obtained from the geological zone of the hydrocarbon-bearing clastic formation.

7. The method of claim 1, wherein the formation information set further comprises condensate content and condensate composition obtained from the geological zone of the hydrocarbon-bearing clastic formation.

8. The method of claim 1, wherein at least a portion of the comparison information set is generated by computer simulation.

9. The method of claim 1, wherein the at least one first surfactant comprises the second surfactant.

10. The method of claim 1, wherein the at least one first solvent comprises the second solvent.

11. The method of claim 1, wherein the second solvent comprises water.

12. The method of claim 1, wherein the second solvent comprises at least one water-miscible organic solvent.

13. The method of claim 1, wherein the second solvent comprises at least two organic solvents.

14. The method of claim 1, wherein the at least one compatibility information set comprises compatibility information regarding the at least one model brine and a plurality of model compositions.

15. The method of claim 14, wherein the plurality of model compositions comprises a third surfactant different from the first surfactant.

16. The method of claim 1, wherein the at least one compatibility information set comprises compatibility information regarding the at least one model brine and a plurality of model compositions at a plurality of model temperatures.

17. The method of claim 14, wherein the plurality of model temperatures has a highest model temperature and a lowest model temperature, and wherein the temperature obtained from the geological zone of the hydrocarbon-bearing clastic formation has a value of from at least the lowest model temperature up to and including the highest model temperature.

18. The method of claim 1, wherein the at least one model temperature comprises a model temperature that has the same value as the temperature obtained from the geological zone of the hydrocarbon-bearing clastic formation.

19. The method of claim 1, wherein the compatibility information set comprises compatibility information regarding a plurality of model brines and a plurality of model compositions at a plurality of model temperatures.

20. The method of claim 1, wherein the at least one model brine is selected based at least in part on the brine composition data obtained from the geological zone of the hydrocarbon-bearing clastic formation.

21. The method of claim 1, wherein at least one model brine has the same composition as the brine composition data obtained from the geological zone of the hydrocarbon-bearing clastic formation.

22. The method of claim 1, wherein the surfactant is fluorinated.

23. The method of claim 1, wherein the surfactant is fluorinated and nonionic.

24. The method of claim 1, further comprising injecting the treatment composition into a specimen of the geological zone of the hydrocarbon-bearing clastic formation.
